(19) United States
(12) Patent Application Publication
(10) Pub. No.: US 2015/0062152 A1
(43) Pub. Date: Mar. 5, 2015

(54) 3-DIMENSIONAL LOOK-UP TABLE-BASED COLOR MASKING TECHNIQUE

(71) Applicant: THOMSON LICENSING, Issy de Moulineaux (FR)

(72) Inventors: Markus Eugen LOEFFLER, Altedena, CA (US); Joshua Pines, San Francisco, CA (US)

(73) Assignee: THOMSON LICENSING, Issy de Moulineaux (FR)

(21) Appl. No.: 14/011,106

(22) Filed: Aug. 27, 2013

(51) Int. Cl. G09G 5/06

(52) U.S. Cl. CPC G09G 5/06
USPC 345/601

(57) ABSTRACT

A method for correcting colors in an image commences by first defining a set of Red-Green-Blue (RGB) color triplets corresponding to user-selected colors defining a designated are of interest in the image to undergo color correction. The set of RGB color triplets are mapped into in a color space defined by cylindrical coordinates to create a three-dimensional look-up table (3D-LUT) that represents a first color range for the designated area of interest. The 3D-LUT undergoes adjustment to establish a second color range. Thereafter, the image is rendered using the 3D-LUT to replace colors in the designated area of interest with colors in the second color range.

### TECHNICAL FIELD

This invention relates to color correcting images.

### TECHNICAL FIELD

During postproduction of image files, including still images as well as image sequences comprising movies or television shows, color correction often occurs to compensate for variations in the captured material (i.e. film errors, white balance, varying lighting conditions) or to influence the viewer's “mood” to match the creative intent of a scene and/or to establish a desired “look”. Color correction operations limited to certain small areas in the image bear the designation “secondary color correction”. Secondary color correction typically consumes substantial computational resources and often take a long time.

Secondary color correction often makes use of a color mask to separate those areas for which color correction should occur as compared to the areas whose color properties should remain untouched. Typical color making techniques make use of the image color space characterized by the Hue, Saturation and Lightness (HSL) or Hue, Saturation, and Value (HSV) coordinates. The HSL and HSV color coordinate systems both make use of cylindrical geometries, with the angular axis representing hue, starting with red (0 degrees), green (120 degrees) and blue (240 degrees), whereas the radial axis represents hue. In the case of the HSL color coordinate, the vertical axis represents lightness (e.g., luminance), whereas in the HSV color coordinate system, the vertical axis represents value. Using one of the HSL or HSV color coordinate systems, a set of distance metrics (i.e. Euclidian distances) from a single or a set of RGB-color points can define a desired color range. The colors that lie inside theses distance metrics become the selected color range and form the desired color mask. Modifying the distance metrics serves to expand or reduce the colors falling into the selected color range defining the desired color mask. For example expanding or reducing the distances along a separate one of the three axes in the HSL color coordinate system serves to adjust hue, saturation and luminance, respectively. In addition to defining the colors that lie fully inside the selected color range, it is also possible to define a blend or “feather” a zone that lies at the border of the selection area.

Traditionally, defining color masks in either the HSL or HSV color coordinate system requires an iterative process that becomes slower with the addition of each new color. Thus a need exists for an improved masking process that does not suffer from the disadvantages of the prior art.

### BRIEF SUMMARY OF THE INVENTION

Briefly, in accordance with an illustrative embodiment of the present principles, a method for correcting colors in an image commences by first defining a set of Red-Green-Blue (RGB) color triplets corresponding to user-selected colors defining a designated area of interest in the image to undergo color correction. The set of RGB color triplets are mapped into in a color space defined by cylindrical coordinates to create a three-dimensional look-up table (3D-LUT) that represents a first color range for the designated area of interest. The 3D-LUT undergoes adjustment to establish a second color range. Thereafter, the image is rendered using the 3D-LUT to replace colors in the designated area of interest with colors in the second color range.

### BRIEF SUMMARY OF THE DRAWINGS

FIG. 1 depicts a block schematic diagram of an illustrative embodiment of apparatus for performing color correction in accordance with the present principles;

FIG. 2 depicts a screen display generated by the apparatus of FIG. 1 in connection with setting a color mask for a designated area of interest in an image for performing color correction in accordance with the present principles;

FIG. 3 depicts a screen display generated by the apparatus of FIG. 1 in connection with expansion of a set of manually picked colors for the designated area of interest in FIG. 2;

FIG. 4 depicts a screen display generated by the apparatus of FIG. 1 illustrating a 3-Dimensional Look-Up Table (3D-LUT) generated in connection with setting the color mask of FIG. 2;

FIG. 5 depicts a screen display generated by the apparatus of FIG. 1 illustrate mapping of colors using the 3D-LUT of FIG. 4;

FIG. 6 depicts a screen display generated by the apparatus of FIG. 1 in connection color correction of designated area of interest in the image using the 3D-LUT of FIG. 4;

FIG. 7 depicts a small portion of the screen display of FIG. 6 showing the same color the same color as selected in FIG. 7 but with expanded luminance; and

FIG. 8 depicts a small portion of the screen display of FIG. 6 showing the same color the same color as selected in FIG. 7 selection but with expanded luminance and a feather.

### DETAILED DESCRIPTION

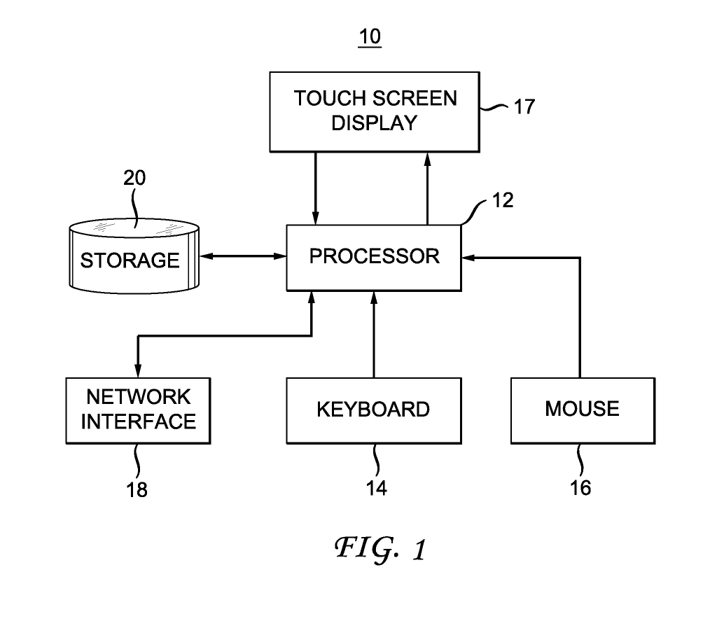

FIG. 1 depicts a block schematic diagram of a system 10 for performing color correction on at least a designated area of interest within an image in accordance with a preferred embodiment of the present principles. The apparatus 10 includes a processor 12, typically in the form of a personal computer (PC), e.g., a laptop or desktop computer, having one or more microprocessors (not shown) and one or more Graphical Processing Units (GPUs), along with internal memory (not shown), including Random Access Memory (RAM) and Read Only Memory (ROM). The GPU(s) could exist as part of the functionality of the microprocessor(s) or as separate stand-alone device embodied within the processor 12.

The processor 12 receives input information from one or more data input devices, such as keyboard 14 and mouse 16 through which an operator can enter commands and/or data. Although not shown, the processor 12 could also receive input signals through a 9-axis controller of the type commonly employed in color correction systems. The processor 12 displays output information via a display 17 device as well known in the art. The display device 17 could comprise a touch-screen device to allow data entry but such functionality is optional and not mandatory. A network interface device 18 connects the processor 12 to a network, for example a Local Area Network (LAN), Wide Area Network (WAN) or the Internet. While FIG. 1 depicts the network interface device 18 as external to the processor 12, in practice, such functionality could exist within the processor 12.

The processor 12 has access to at least one storage device 20, typically in the form of a hard disk drive or the like, storing data and/or program instructions. In practice, the storage device 20 stores image information, typically in the form of one or more still images, or a succession of images (video) to undergo color correction in the manner described hereinafter. The program instruction typically include an operating such as the Microsoft Windows® operating system as well as one or more application programs, including an application program for color correction modified in accordance with the present principles.

Although not shown, the processor 12 can access other storage devices For example, the processor 12 could access a CD-ROM, DVD, a read-only and/or DVD drive and/or a DVD Read/Write drive, all known in the art. Further, the processor 12 could access one or more Universal Serial Bus (USB)-type storage devices (e.g., “memory sticks.”) through corresponding USB ports (not shown).

To carry out color correction (sometimes referred to as color grading), the processor 12 makes use of commercial color grading software, modified in accordance with the present principles, as described hereinafter. In the illustrated embodiment, the processor 12 makes use of the CineStyle Color Assist color grading software, previously available from Technicolor, Hollywood, Calif., modified as discussed hereinafter. Other commercially available color grading programs include Color Finesse, available from Synthetic Aperture, DaVinci Resolve, available from Black Magic Design, and Magic Bullet Colorista II from Red Giant Software.

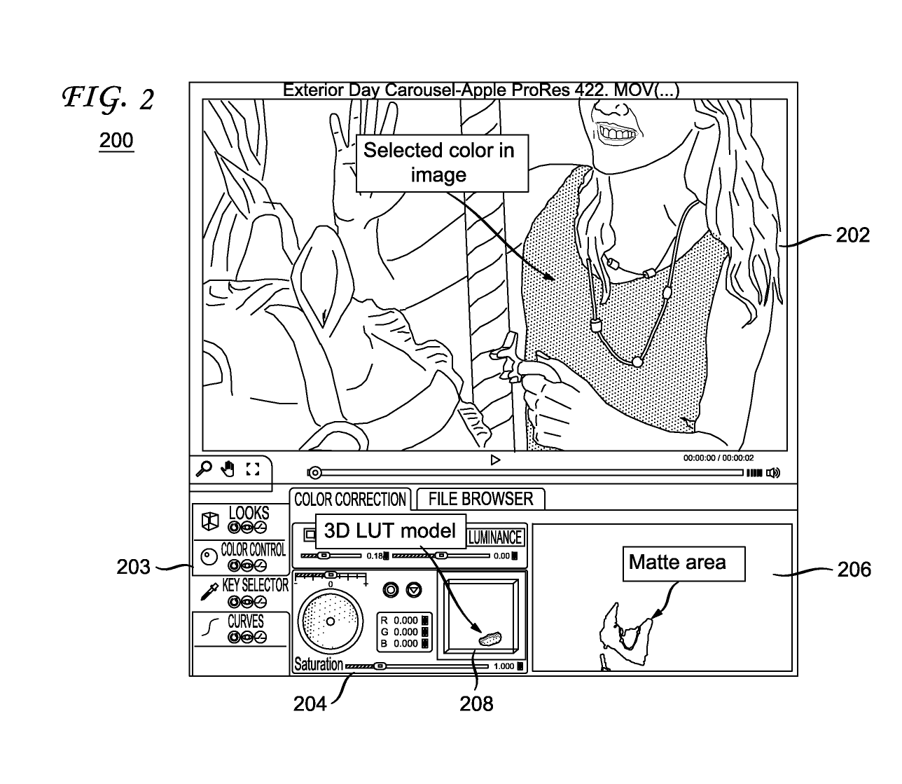

To better understand the manner in which the system 10 of FIG. 1 accomplishes color correction in accordance with the present principles, refer to FIG. 2, which depicts a screen shot 200 displayed by the touch screen display 17 of FIG. 1 in connection with execution of the CineStyle Color Assist color grading (color correction) software. The screen shot 200 of FIG. 2 includes a first display area 202 that displays the image, either a complete frame of the still image or a selected image frame of a sequence of images of a video stream, for example a movie or a television program. Additionally, the screen shot 200 of FIG. 2 includes a second display area 203 that displays a control panel associated with the CineStyle Color Assist color grading software program for enabling a user to select an area of interest within the display area 202 for color correction (“secondary color correction”). The control panel depicted in the display area 203 of FIG. 2 includes adjustment settings for different looks, color controls, keys and curves, for example. Additionally, the control panel depicted in the display area 203 of FIG. 2 includes a color selection sub-control panel 204. The color selection sub-control panel 204 depicted in the sub-display area 203 has settings, which allows the user to select color(s) specified by RGB color triplets to create a 3-Dimensional Look-Up Table (3D-LUT) in accordance with the present principles. The 3D-LUT functions as a color mask for performing color correction.

To understand the process of creating the 3D-LUT, assume for purposes of discussion that the user wants to change the color of the dress worn by the woman appearing in the image displayed in the display area 202 of FIG. 2. (Thus, the woman's dress in the display area 202 constitutes the area of interest for color correction). To select the color of the dress, the user simply clicks with the mouse anywhere on the dress to capture a shade of the red color. The user can then use the controls provided in the sub-display 204 to change the color (to green in this example) or expand/shrink the selection of colors. The women's dress appears as the matte area in the display area 206.

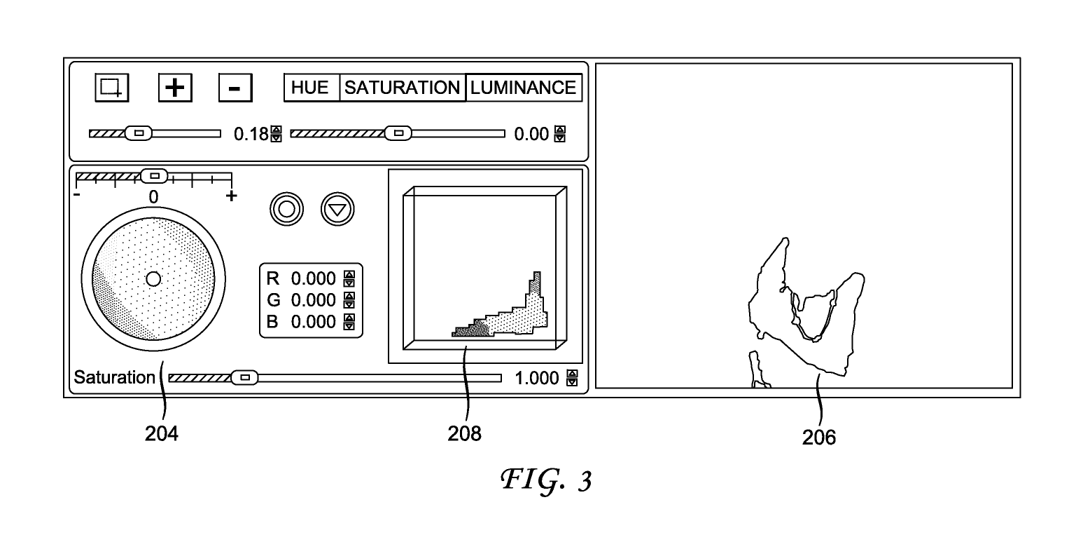

To create the 3D-LUT, the user will select a set of RGB color triplets from the image to define the desired color for correction (i.e., the color of the woman's dress in the image displayed in the display area 202 of FIG. 2). Thereafter, the processor 12 of FIG. 1 converts the RGB triplets into the HSV color space system described previously. The user can easily manipulate the hue, saturation and value (luminance) parameters by using the control sub-panel depicted in the sub-display area 204. Converting the RGB triplets into the HSV color coordinate system creates a 3D-LUT depicted in the window 208 in the sub-display area 204 of FIG. 3. This 3D-LUT contains only the “masked” color(s), thus defining the desired color mask. In addition to using the control sub-panel 204 to manipulate hue, saturation and value (luminance) parameters, the user can interactively add or subtract RGB triplets in the linked list.

As discussed above, the user selects the color(s) used as a color mask by selecting a set of RGB triplets (sometimes referred to as a linked list of RGB points) stored by the processor 12 of FIG. 1. By mapping the user selected set of RGB triplets (i.e., the linked list of RGB points) into the HSV color space, the processor 12 thus creates the 3D-LUT of the present principles. To avoid hard edges or contours which can occur when a pixel in the image falls inside the specified color range and a neighboring pixel falls outside the range, the user can specify “feathering” or fall-off effect to control how sharply or gently to apply the color correction inside the specified color range so color correction tapers off for pixels whose color falls outside the range. FIG. 3 depicts a portion of the screen shot 200 showing only display area 204 and sub-display area 208, as well as the display area 206 to illustrate how the user can adjust the various setting appearing in the display area 204 to accomplish such feathering.

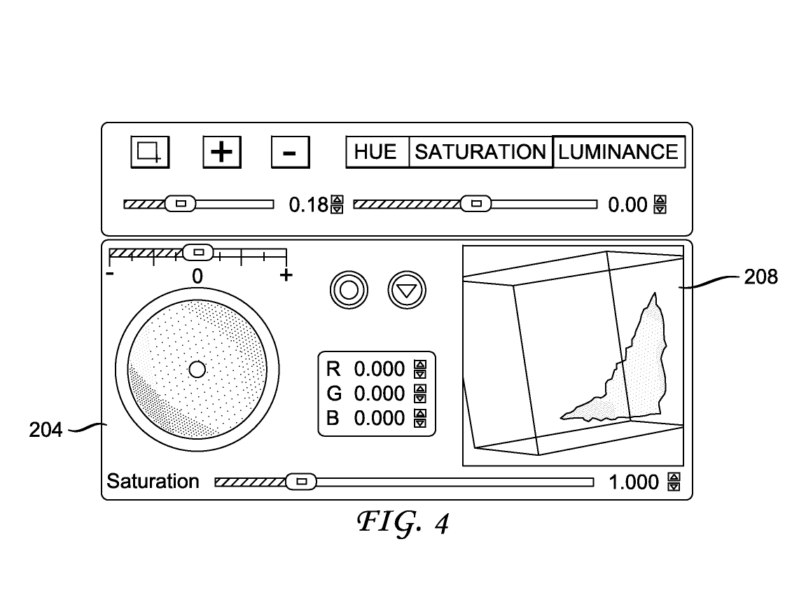

By replacing the color(s) specified in the 3D-LUT with new colors, the user can accomplish color correction of the designated area of interest in the image using the 3D-LUT of the present principles. FIG. 4 depicts the window 208 in the sub-display area 204 of FIG. 2 following a mapping of selected new colors the 3D-LUT. As depicted in FIG. 4, the user has rotated the 3D-LUT in the display area 208 in a different orientation as compared to the orientation of the 3D-LUT in FIG. 3. By rotating the 3D-LUT, the user can visually inspect the 3D-LUT from different angles to identify colors accidentally picked.

To summarize, using the color grading software executed by the processor 12, the user creates the 3D-LUT via the following steps

1) The user selects the color(s) that define a color mark for secondary color correction in an area of interest in the image.

2) The processor 12 establishes a set of RGB triplets defining the color mask for subsequent storage in a list. The user can augment this list by adding colors from the image.

3) The processor 12 maps the RGB triplet point cloud into the HSV color space to create the 3D-LUT.—The user can easily manipulate the 3D-LUT in this color space by adjusting the hue, saturation and luminance axis via the control on the sub-panel 204.

The resulting 3D-LUT contains only the masked colors, which can creatively be replaced by new colors.

During playback of the image, the processor 12 can apply the 3D-LUT created in the manner described to the image in real-time using tri-linear interpolations algorithms for pixel shaders embodied with in GPUs in the processor 12 to perform the desired color correction. FIG. 5 depicts the results of color selection and replacement using the 3D-LUT. In comparison to FIG. 2, the color of the woman's dress in the display area 202 of FIG. 5 changes in accordance with color correction obtained using the 3D-LUT to map new colors for the existing colors in the designated region of interest.

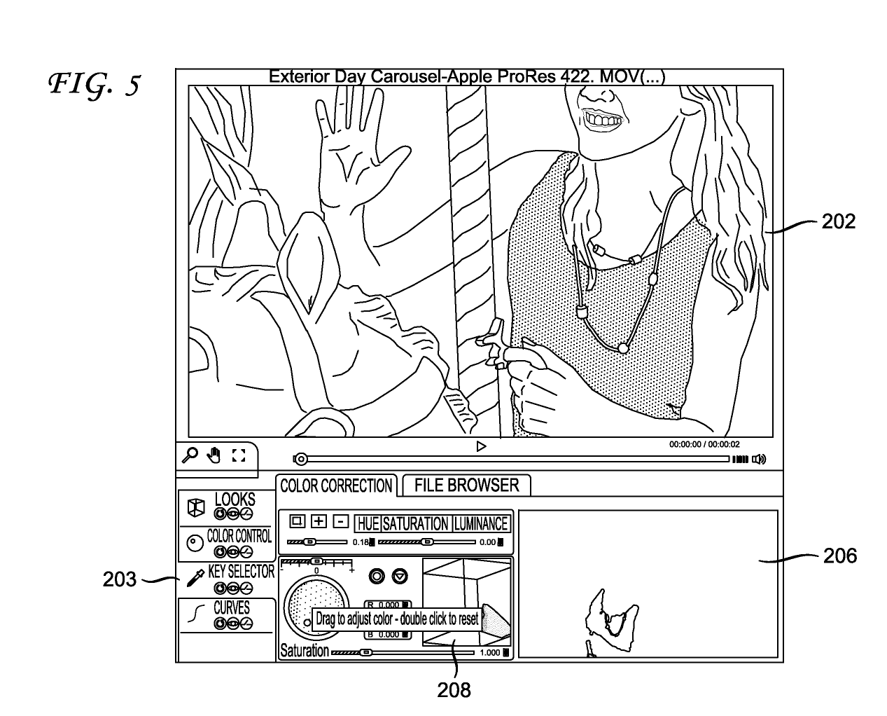

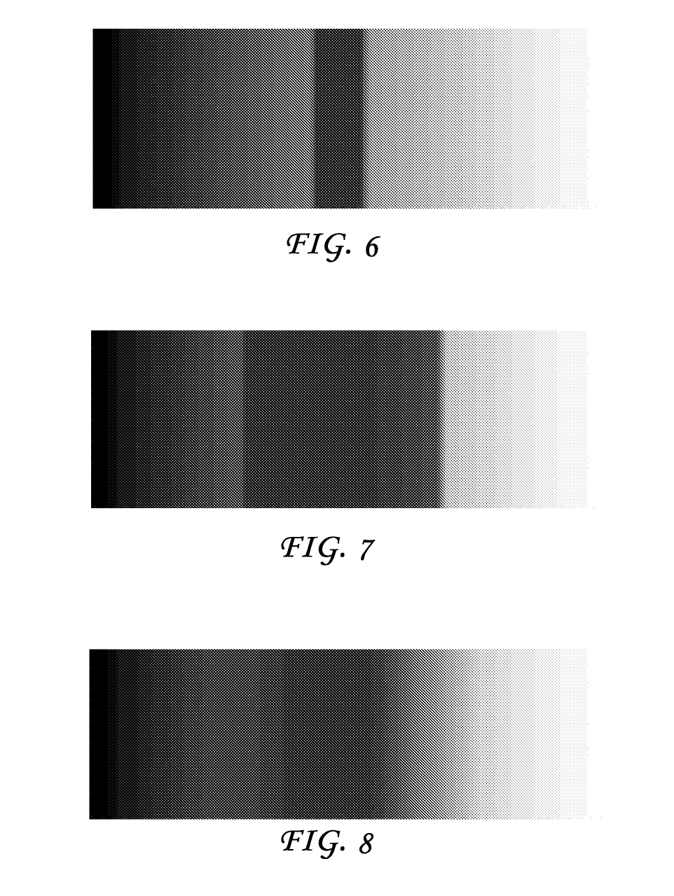

FIG. 6 depicts a portion of the color inside the 3D-LUT in the display area 208 of FIG. 5 showing replacement with a different color.

FIG. 7 depicts a portion of the color inside the 3D-LUT in the display area 208 of FIG. 5 showing the same color as FIG. 6 with expanded luminance selected by the user. FIG. 8 depicts a portion of the color inside the 3D-LUT in the display area 208 of

FIG. 5 showing the same color as FIG. 6 with expanded luminance and feathering

Using the 3D-LUT created in the manner described above achieves a dramatic speed improvement and enables color correction in real-time. Using the 3D-LUT of the present principles affords the advantage that the processing time remains linear regardless of the number of colors in the selected mask. Prior art solutions used iterative algorithms, which caused decrease in speed with the addition of more mask colors.

The foregoing describes a method and apparatus for color correcting images. While the color correction technique of the present principles has been described in connection with the CineStyle Color Assist color grading software program, those skilled in the art should readily appreciate that other color grading (color correction) software programs could serve the same function. In other words, such other color grading programs could readily undergo modification to create a color mask from a 3D-LUT obtained by mapping a user-selected set of RGB triplets into a color space such as HSL or HSV in accordance with the present principles.

1. A method for correcting colors in an image, comprising the steps of:
defining a set of Red-Green-Blue (RGB) color triplets corresponding to user-selected colors defining a designated area of interest in the image to undergo color correction;
mapping the set of RGB color triplets in a color space defined by cylindrical coordinates to create a three-dimensional look-up table (3D-LUT) that represents a first color range for the designated area of interest;
adjusting the 3D-LUT to establish a second color range; and
rendering the image using the adjusted 3D-LUT to replace colors in the designated area of interest with colors in the second color range.

2. The method according to claim 1 wherein the color space comprises the Hue, Saturation, Value (HSV) color space.

3. The method according to claim 1 wherein the mapping step includes adjusting the 3D-LUT to control fall-off between image pixels lying inside and outside the first color range.

4. The method according to claim 3 wherein the adjusting occurs in response to user input.

5. The method according to claim 1 wherein the 3D-LUT is adjusted in response to user input.

6. The method according to claim 1 wherein the user interacts with the set of RGB triplets to add or subtract RGB color triplets from the set.

7. A system for color correction of an image, comprising:
storage means for storing the image;
user-input means for receiving user input; and
a processor coupled to the storage means and the user-input means for (a) defining a set of Red-Green-Blue (RGB) color triplets corresponding to user-selected colors entered through the user-input means defining a designated area of interest in the image to undergo color correction; (b) mapping the set of RGB color triplets in a color space defined by cylindrical coordinates to create a three-dimensional look-up table (3D-LUT) that represents a first color range for the designated area of interest; (c) adjusting the 3D-LUT to establish a second color range; and (d) rendering the image using the adjusted 3D-LUT to replace colors in the designated area of interest with colors in the second color range.

8. The system according to claim 7 wherein the color space comprises the Hue, Saturation, Value (HSV) color space.

9. The system according to claim 7 wherein the mapping performed by the processor includes adjusting the 3D-LUT to control fall-off between image pixels lying inside and outside the first color range.

10. The system according to claim 7 wherein the processor adjusts the 3D-LUT in response to user input received through the user input means.
